(19) United States
(12) Patent Application Publication
(10) Pub. No.: US 2024/0371086 A1
(43) Pub. Date: Nov. 7, 2024

(54) METHOD AND APPARATUS FOR RENDERING VIRTUAL SCENE, DEVICE, AND STORAGE MEDIUM

(71) Applicant: Tencent Technologgy (Shenzhen) Company Limited, Shenzhen (CN)

(72) Inventor: Mengzhe ZHU, Shenzhen (CN)

(21) Appl. No.: 18/775,925

(22) Filed: Jul. 17, 2024

Related U.S. Application Data
(63) Continuation of application No. PCT/CN2023/088979, filed on Apr. 18, 2023.

(30) Foreign Application Priority Data
Jun. 17, 2022 (CN) 202210690977.5

(51) Int. Cl. G06T 15/50; G06T 15/04

(52) U.S. Cl. CPC G06T 15/506; G06T 15/04

(57) ABSTRACT

Embodiments of this application disclose a method for rendering a virtual scene performed by a computer device. The method includes: performing geometry rendering on the virtual scene at a geometry rendering stage, to obtain a geometry rendering result; writing the geometry rendering result into an on-chip memory in a GPU; reading the geometry rendering result from the on-chip memory based on an expansion characteristic in which the GPU reads data from the on-chip memory at an illumination rendering stage; performing illumination rendering based on light source information and the geometry rendering result, to obtain an illumination rendering result; and writing the illumination rendering result into the on-chip memory. By using the solutions provided in the embodiments of this application, in a rendering process, the geometry rendering result no longer needs to be stored in the main memory, thereby reducing bandwidth consumption.

### CROSS-REFERENCE TO RELATED APPLICATIONS

This application is a continuation application of PCT Patent Application No. PCT/CN2023/088979, entitled “METHOD AND APPARATUS FOR RENDERING VIRTUAL SCENE, DEVICE, AND STORAGE MEDIUM” filed on Apr. 18, 2023, which claims priority to Chinese Patent Application No. 202210690977.5, entitled “METHOD AND APPARATUS FOR RENDERING VIRTUAL SCENE, DEVICE, AND STORAGE MEDIUM” filed on Jun. 17, 2022, both of which are incorporated herein by reference in their entirety.

### FIELD OF THE TECHNOLOGY

Embodiments of this application relate to the field of rendering technologies, and in particular, to a method and apparatus for rendering a virtual scene, a device, and a storage medium.

### BACKGROUND OF THE DISCLOSURE

Multi-light source processing is always an important part for rendering a virtual scene. In the related art, most graphics processing units (GPUs) of a mobile platform perform rendering on the virtual scene by using a tile base rendering (TBR) mode.

After a geometry rendering stage ends, a GPU needs to write a geometry buffer (G-Buffer) including a tile rendering result into a main memory, and then re-reads the geometry buffer from the main memory at an illumination rendering stage, to complete illumination rendering based on the tile rendering result.

Because frequent writing and reading operations need to be performed with the main memory in a rendering process, a large amount of bandwidth needs to be consumed, resulting in high power consumption in the rendering process.

### SUMMARY

Embodiments of this application provide a method and apparatus for rendering a virtual scene, a device, and a storage medium, which can reduce bandwidth consumption during virtual scene rendering. The technical solutions are as follows:

According to an aspect, an embodiment of this application provides a method for rendering a virtual scene, performed by a computer device, the method including:
performing geometry rendering on the virtual scene at a geometry rendering stage, to obtain a geometry rendering result;
writing the geometry rendering result into an on-chip memory in a GPU;
reading the geometry rendering result from the on-chip memory based on an expansion characteristic in which the GPU reads data from the on-chip memory at an illumination rendering stage;
performing illumination rendering based on light source information and the geometry rendering result, to obtain an illumination rendering result; and
writing the illumination rendering result into the on-chip memory.

According to another aspect, an embodiment of this application provides a computer device, including a processor and a memory, the memory having at least one instruction stored therein that, when executed by the processor, causes the computer device to implement the method for rendering a virtual scene according to the foregoing aspects.

According to another aspect, an embodiment of this application provides a non-transitory computer-readable storage medium, having at least one piece of program code stored therein that, when executed by a processor of the computer device, causes the computer device to implement the method for rendering a virtual scene according to the foregoing aspects.

In the embodiments of this application, a GPU writes a geometry rendering result obtained at a geometry rendering stage into an on-chip memory of the GPU instead of a main memory, reads the geometry rendering result from the on-chip memory based on an expansion characteristic at an illumination rendering stage, to perform illumination rendering in combination with light source information, and writes an illumination rendering result into the on-chip memory. By using the solutions provided in the embodiments of this application, the GPU can directly read the geometry rendering result from the on-chip memory at the illumination rendering stage by using the expansion characteristic, which eliminates a link of writing the geometry rendering result into the main memory and reading the geometry rendering result from the main memory, reducing bandwidth consumption during rendering of a virtual environment.

### BRIEF DESCRIPTION OF THE DRAWINGS

FIG. 1 is a schematic diagram of a rendering process in the related art.

FIG. 2 is a flowchart of a method for rendering a virtual scene according to an exemplary embodiment of this application.

FIG. 3 is a schematic diagram of an implementation of a virtual scene rendering process according to an exemplary embodiment of this application.

FIG. 4 is a flowchart of a method for rendering a virtual scene according to another exemplary embodiment of this application.

FIG. 5 is a schematic diagram of an implementation of a virtual scene rendering process according to an exemplary embodiment of this application.

FIG. 6 is a schematic diagram of another implementation of a virtual scene rendering process according to an exemplary embodiment of this application.

FIG. 7 is a flowchart of a method for rendering a virtual scene according to another exemplary embodiment of this application.

FIG. 8 is a schematic diagram of an implementation of a virtual scene rendering process according to another exemplary embodiment of this application.

FIG. 9 is a schematic diagram of another implementation of a virtual scene rendering process according to another exemplary embodiment of this application.

FIG. 10 is a flowchart of implementing multi-light source rendering based on an expansion characteristic according to an exemplary embodiment of this application.

FIG. 11 is a structural block diagram of an apparatus for rendering a virtual scene according to an exemplary embodiment of this application.

FIG. 12 is a schematic structural diagram of a computer device according to an exemplary embodiment of this application.

### DESCRIPTION OF EMBODIMENTS

To make the objectives, technical solutions, and advantages of this application clearer, the following describes implementations of this application in further detail with reference to the accompanying drawings.

Since bandwidth of a mobile platform is limited, in a process of deferred rendering performed by the mobile platform, a TBR rendering mode is mostly used to render a virtual scene.

The process of deferred rendering mainly includes a geometry rendering stage and an illumination rendering stage. At the geometry rendering stage, a GPU calculates and draws geometry data corresponding to the virtual scene, to obtain a geometry rendering result, and stores the geometry rendering result in a geometry buffer (G-Buffer); and at the illumination rendering stage, the GPU performs illumination calculation and processing based on the geometry rendering result and light source information, to obtain an illumination rendering result, and finally completes rendering of the virtual scene.

In the TBR rendering mode, the GPU divides a scene picture into several tiles according to a capacity of an on-chip memory, performs geometry rendering and illumination rendering processing on each slice, to obtain an illumination rendering result corresponding to each tile, and then splices final illumination rendering results, to complete rendering of an entire scene.

In the related art, after geometry rendering is performed on each tile, the geometry buffer storing the geometry rendering result is written into a main memory, and at the illumination rendering stage, the geometry rendering result in the geometry buffer needs to be re-read from the main memory and undergoes illumination rendering. Since the main memory stores a large amount of data and has a slow transmission speed, in a rendering process, the GPU needs to continuously perform writing and reading operations on the geometry buffer with the main memory, which increases bandwidth consumption and leads to more power consumption.

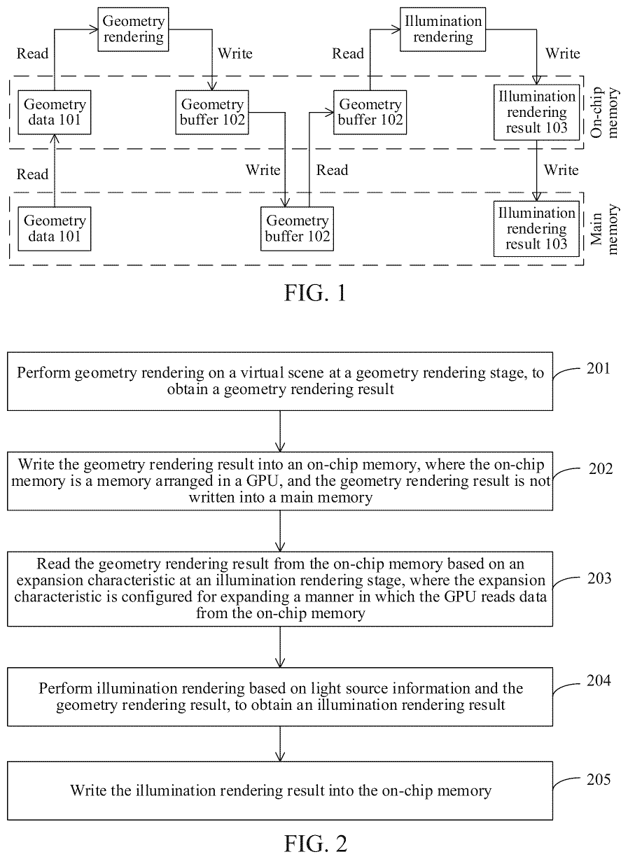

For example, as shown in FIG. 1, in the related art, the GPU reads geometry data 101 of the virtual scene from the main memory and places the geometry data 101 in the on-chip memory, reads the geometry data 101 from the on-chip memory to perform geometry rendering processing, writes a geometry rendering result into a geometry buffer 102 of the on-chip memory, and writes the geometry buffer 102 into the main memory.

When performing illumination rendering processing, the GPU reads the geometry buffer 102 from the main memory into the on-chip memory, performs illumination rendering processing on the geometry rendering result of the geometry buffer 102 in the on-chip memory to obtain an illumination rendering result 103, writes the illumination rendering result 103 into the on-chip memory, and finally writes the illumination rendering result 103 into the main memory.

To reduce bandwidth consumption during rendering of the virtual scene, in the embodiments of this application, the GPU writes the geometry rendering result into the on-chip memory and no longer writes the geometry rendering result into the main memory. At the illumination rendering stage, by using an expansion characteristic, the GPU directly reads the geometry rendering result from the on-chip memory to perform illumination rendering. In the rendering process, each tile is rendered through interaction between the GPU and the on-chip memory, without midway writing the geometry rendering result into the main memory, thereby avoiding bandwidth consumption caused by frequent writing and reading operations with the main memory, helping improve rendering efficiency, and reducing power consumption in the rendering process.

The solutions provided in the embodiments of this application may be applied to an application program supporting a virtual environment, for example, a game application program supporting a virtual environment, a virtual reality (VR) application program, an augmented reality (AR) application program, or the like. A specific application scenario is not limited in the embodiments of this application.

In addition, the solutions provided in the embodiments of this application may be performed by a computer device (for example, a smartphone, a tablet computer, or a personal portable computer) of a mobile platform. A GPU is arranged in the computer device, and an application program having a virtual environment rendering requirement is run on the computer device. Since bandwidth consumption in the rendering process can be reduced when rendering is performed on a virtual environment including complex illumination, it is helpful to improve device battery life.

FIG. 2 is a flowchart of a method for rendering a virtual scene according to an exemplary embodiment of this application. The method may include the following operations:

Operation 201: Perform geometry rendering on a virtual scene at a geometry rendering stage, to obtain a geometry rendering result.

Since each virtual object in the virtual scene is presented in a form of a three-dimensional model, at the geometry rendering stage, the GPU needs to process geometry data corresponding to the three-dimensional model of each virtual object in the virtual scene. Through drawing at the geometry rendering stage, the geometry data of each virtual object is transformed from a three-dimensional space to a screen space, to obtain a geometry rendering result corresponding to the screen space.

In some embodiments, the geometry rendering result may include information that can represent a state of the virtual object, such as color information, normal information, ambient occlusion information, and reflection information of the virtual object in the virtual scene. This is not limited in the embodiments of this application.

In a possible implementation, geometry rendering processing may include procedures such as vertex shading, coordinate transformation, primitive generation, projection, cropping, and screen mapping. The GPU performs the geometry rendering processing on each virtual object in the virtual scene, to obtain the geometry rendering result corresponding to each virtual object in the virtual scene.

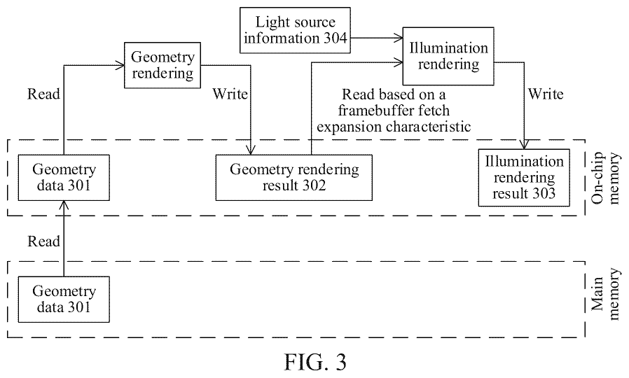

For example, as shown in FIG. 3, at the geometry rendering stage, the GPU reads geometry data 301 corresponding to the virtual scene, and based on the geometry data 301, the GPU performs geometry rendering processing on the virtual scene, to obtain a geometry rendering result 302.

Operation 202: Write the geometry rendering result into an on-chip memory, where the on-chip memory is a memory arranged in a GPU, and the geometry rendering result is not written into a main memory.

In some embodiments, the on-chip memory is a memory arranged in the GPU, and is a cache, which has characteristics of a fast speed, a small capacity, and low consumption. The main memory (also referred to as a system memory) has a large capacity and a slow transmission speed, and requires a large amount of bandwidth consumption while performing data reading and writing with the main memory.

Since the on-chip memory has a small capacity, in some embodiments, when a TBR rendering mode is enabled, the GPU writes the geometry rendering result into the on-chip memory. If the TBR rendering mode is not enabled, the TBR rendering mode first needs to be enabled.

In the TBR rendering mode, the GPU divides a virtual scene picture into several tiles according to a capacity of the on-chip memory, and performs rendering processing on each tile, so that writing and reading of rendering data can be completed by using the on-chip memory, thereby improving rendering efficiency.

In a possible implementation, the GPU writes the geometry rendering result into the on-chip memory, and the geometry rendering result is not written into the main memory until all rendering stages are completed. The GPU only performs writing and reading of the rendering data on the on-chip memory.

For example, as shown in FIG. 3, the GPU writes the generated geometry rendering result 302 into the on-chip memory instead of the main memory.

Operation 203: Read the geometry rendering result from the on-chip memory based on an expansion characteristic at an illumination rendering stage, where the expansion characteristic is configured for expanding a manner in which the GPU reads data from the on-chip memory.

Since the geometry rendering result is only written into the on-chip memory and not written into the main memory, the GPU needs to use the expansion characteristic to read the geometry rendering result from the on-chip memory. The expansion characteristic is configured for expanding the manner in which the GPU reads data from the on-chip memory (without passing through the main memory). In this embodiment of this application, the expansion characteristic is configured for expanding a manner in which the GPU reads the geometry rendering result from the on-chip memory without passing through the main memory.

In some embodiments, the expansion characteristic is configured for allowing a fragment shader to directly access the on-chip memory.

In some embodiments, the expansion characteristic is a framebuffer fetch expansion characteristic.

In a possible implementation, based on the expansion characteristic, the GPU directly reads the geometry rendering result from the on-chip memory, including the color information, the normal information, the ambient occlusion information, the reflection information, and the like of the virtual object in the virtual scene.

For example, as shown in FIG. 3, based on the expansion characteristic, the GPU directly reads the geometry rendering result 302 obtained at the geometry rendering stage from the on-chip memory.

Operation 204: Perform illumination rendering based on light source information and the geometry rendering result, to obtain an illumination rendering result.

Multi-light source illumination exists in most virtual scenes, a same virtual object has a plurality of light sources for illumination, and a same light source also illuminates a plurality of virtual objects. Therefore, to represent an illumination state of each virtual object in the virtual scene, the GPU performs illumination rendering based on different light source information and the geometry rendering result, to obtain the illumination rendering result.

In some embodiments, the light source information may be divided according to a light source type, and different drawing forms are used for different types of light sources.

For example, as shown in FIG. 3, the GPU performs illumination rendering based on light source information 304 and the geometry rendering result 302, to obtain an illumination rendering result 303.

Operation 205: Write the illumination rendering result into the on-chip memory.

Further, the GPU writes the illumination rendering result into the on-chip memory, to complete rendering of a tile in the virtual scene. For each tile corresponding to the virtual scene picture, a computer device repeats the foregoing operations until all tiles are rendered.

For example, as shown in FIG. 3, the GPU writes the illumination rendering result 303 into the on-chip memory.

In summary, in the embodiments of this application, a GPU writes a geometry rendering result obtained at a geometry rendering stage into an on-chip memory of the GPU instead of a main memory, reads the geometry rendering result from the on-chip memory based on an expansion characteristic at an illumination rendering stage, to perform illumination rendering in combination with light source information, and writes an illumination rendering result into the on-chip memory. By using the solutions provided in the embodiments of this application, the GPU can directly read the geometry rendering result from the on-chip memory at the illumination rendering stage by using the expansion characteristic, which eliminates a link of writing the geometry rendering result into the main memory and reading the geometry rendering result from the main memory, reducing bandwidth consumption during rendering of a virtual environment.

In a possible implementation, the GPU uses a vertex shader and a fragment shader to perform rendering at the geometry rendering stage and the illumination rendering stage respectively, and creates a render texture in the geometry buffer of the on-chip memory. By storing the geometry rendering result into the render texture, reading of the geometry rendering result is implemented. Detailed descriptions are provided below by using specific embodiments.

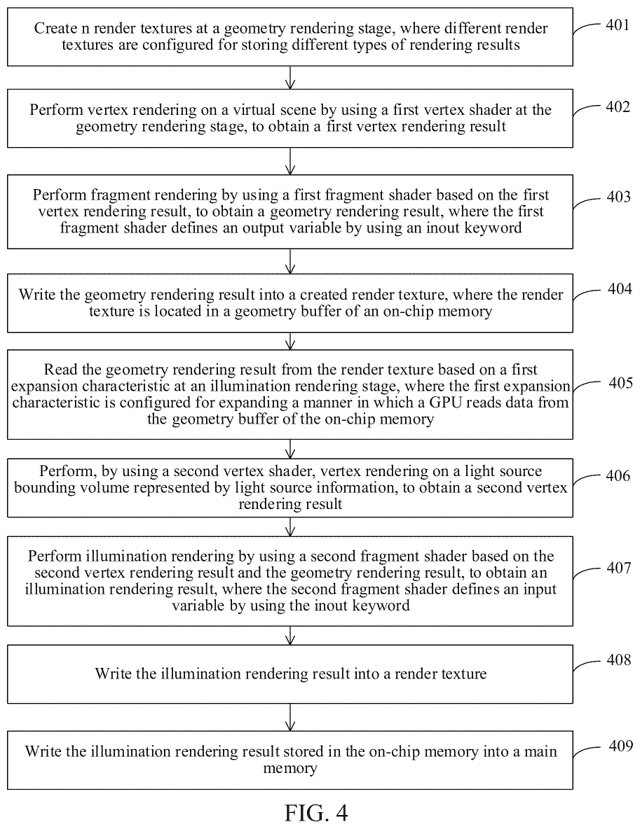

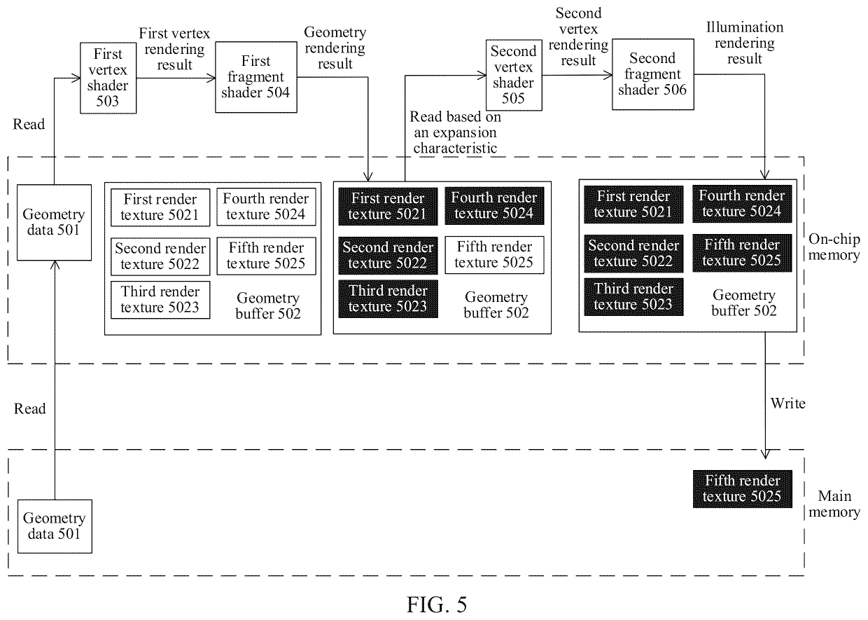

FIG. 4 is a flowchart of a method for rendering a virtual scene according to another exemplary embodiment of this application. The method may include the following operations:

Operation 401: Create n render textures at a geometry rendering stage, where different render textures are configured for storing different types of rendering results, and the render textures are located in a geometry buffer of an on-chip memory.

To store different types of rendering results, the GPU creates n render textures to store the different types of rendering results into different render textures, where n is an integer greater than or equal to 2.

In addition, to avoid switching of render textures occurring at the geometry rendering stage and the illumination rendering stage, in this embodiment of this application, the n render textures created by the GPU are further configured for storing, in addition to the geometry rendering result at the geometry rendering stage, the illumination rendering result at the illumination rendering stage, that is, both geometry rendering and illumination rendering are completed based on the created render textures.

In a possible implementation, the geometry rendering result and the illumination rendering result may be stored in different render textures.

For example, as shown in FIG. 5, the GPU creates five render textures (located in a geometry buffer 502), where a first render texture 5021 is configured for storing color and ambient occlusion (AO) information of the virtual object, a second render texture 5022 is configured for storing normal information of the virtual object, a third render texture 5023 is configured for storing spontaneous light and highlights information of the virtual object, a fourth render texture 5024 is configured for storing depth information of the virtual object, and a fifth render texture 5025 is configured for storing a final rendering result at the illumination rendering stage.

In this embodiment, an example in which only five render textures are created is used for illustrative description. In an actual application, a quantity and a type of render textures may be set according to requirements. The quantity and type of render textures are not limited in this embodiment.

Operation 402: Perform vertex rendering on the virtual scene by using a first vertex shader at the geometry rendering stage, to obtain a first vertex rendering result.

In a possible implementation, the GPU first determines rendering information of each vertex by using the first vertex shader, so that vertices can be set and assembled into a point, a line, and a triangle based on the determined vertex information.

In a possible implementation, the GPU performs vertex rendering on the virtual scene by using the first vertex shader, where the first vertex shader is applied to each vertex of the virtual object. In addition to position information, the vertex may further include information such as a normal and a color. By using the first vertex shader, the GPU can transform the vertex information of the virtual object from a model space to a screen space, to obtain the first vertex rendering result.

For example, as shown in FIG. 5, the GPU reads geometry data 501 of the virtual scene, and performs vertex rendering on the virtual scene by using a first vertex shader 503, to obtain the first vertex rendering result.

Operation 403: Perform fragment rendering by using a first fragment shader based on the first vertex rendering result, to obtain a geometry rendering result, where the first fragment shader defines an output variable by using an inout keyword.

Further, to obtain a color and other attributes of an entire scene, based on the first vertex rendering result (and other information such as other maps of the virtual scene), the GPU performs fragment rendering by using the first fragment shader, to render all fragments in a manner of rendering a triangle (formed by vertices), to obtain the geometry rendering result.

In a possible implementation, to ensure that subsequent illumination rendering still uses the render textures obtained at the geometry rendering stage and avoid switching of render textures, in this embodiment, the first fragment shader defines the output variable by using the inout keyword. To be specific, the geometry rendering result is defined by the inout keyword, so that the geometry rendering result serves as both an input and an output. Through the method of defining the output variable by using the inout keyword, when the variable changes, an original value can be replaced with a changed value, thereby achieving real-time updating of the geometry rendering result and ensuring that the render textures obtained at the geometry rendering stage can be accurately read at a subsequent illumination rendering stage.

For example, as shown in FIG. 5, based on the first vertex rendering result, the GPU performs fragment rendering by using a first fragment shader 504, to obtain the geometry rendering result.

Operation 404: Write the geometry rendering result into a created render texture.

According to different types corresponding to the created render textures, the GPU writes the geometry rendering result into a corresponding render texture.

In a possible implementation, the render texture is located in the geometry buffer of the on-chip memory, where the geometry buffer may store information related to each virtual object in the virtual scene, to meet a calculation requirement at the subsequent illumination rendering stage.

In a possible implementation, the GPU writes the geometry rendering result into first to (n−1)^{th} render textures, where the first to (n−1)^{th} render textures correspond to different types of rendering results at the geometry rendering stage, and an n^{th} render texture is configured for storing a final rendering result at the illumination rendering stage.

For example, as shown in FIG. 5, there are five render textures in the geometry buffer 502 of the on-chip memory. The GPU writes the color and ambient occlusion information of the virtual object obtained at the geometry rendering stage into the first render texture 5021, writes the normal information of the virtual object into the second render texture 5022, write the spontaneous light and highlights information of the virtual object into the third render texture 5023, and writes the depth information of the virtual object into the fourth render texture 5024.

Operation 405: Read the geometry rendering result from the render texture based on a first expansion characteristic at an illumination rendering stage, where the first expansion characteristic is configured for expanding a manner in which a GPU reads data from the geometry buffer of the on-chip memory.

In a possible implementation, at the illumination rendering stage, the GPU reads a corresponding geometry rendering result from each render texture based on the first expansion characteristic, where the first expansion characteristic is configured for expanding the manner in which the GPU reads the data from the geometry buffer of the on-chip memory. In this embodiment of this application, the first expansion characteristic is configured for expanding a manner in which the GPU reads the geometry rendering result in each render texture from the geometry buffer of the on-chip memory, and the read render texture is a render texture that stores the geometry rendering result at the geometry rendering stage.

In an exemplary example, the first expansion characteristic is a mobile platform GPU OpenGLES GL_EXT_shader_framebuffer_fetch expansion characteristic.

Operation 406: Perform, by using a second vertex shader, vertex rendering on a light source bounding volume represented by light source information, to obtain a second vertex rendering result.

Due to complex types of light sources in a multi-light source virtual scene, there is direct light that affects the entire scene, and illumination calculation needs to be performed pixel by pixel, and there is also a local light source that affects a part of region and affects only some pixels on a screen, so that the illumination calculation does not need to be performed pixel by pixel. Therefore, the GPU draws a corresponding light source bounding volume according to different light source information, where a size of the bounding volume is greater than or equal to an attenuation range of the light source.

In some embodiments, different types of light sources correspond to light source bounding volumes in different forms. For example, a full-screen quadrilateral bounding volume is used for direct illumination, a spherical bounding volume is used for a point light source, and a conical bounding volume is used for a spotlight.

Further, the GPU performs vertex rendering on the light source bounding volume represented by the light source information by using the second vertex shader, and transforms and projects vertices of the light source bounding volume to a corresponding region on the screen, to obtain the second vertex rendering result.

For example, as shown in FIG. 5, the GPU performs, by using a second vertex shader 505, vertex rendering on the light source bounding volume represented by the light source information, to obtain the second vertex rendering result.

Operation 407: Perform illumination rendering by using a second fragment shader based on the second vertex rendering result and the geometry rendering result, to obtain an illumination rendering result, where the second fragment shader defines an input variable by using the inout keyword.

Corresponding to that the second fragment shader uses the inout keyword to define the output variable at the geometry rendering stage, to read the geometry rendering result based on the expansion characteristic and use the geometry rendering result at the illumination rendering stage, the second fragment shader obtains the geometry rendering result (that is, the render texture) obtained at the geometry rendering stage by defining the input variable by using the inout keyword, and calculates, based on the second vertex rendering result, the geometry rendering result by using an illumination equation, to obtain the illumination rendering result.

In an exemplary example, the GPU calculates the color and ambient occlusion information, the normal information, and the spontaneous light and highlights information by using the illumination equation, to obtain the illumination rendering result.

For example, as shown in FIG. 5, based on the second vertex rendering result and the geometry rendering result, the GPU performs illumination rendering by using a second fragment shader 506, to obtain the illumination rendering result.

Operation 408: Write the illumination rendering result into a render texture.

Further, the GPU writes the illumination rendering result into the n^{th} render texture.

For example, as shown in FIG. 5, the GPU writes the illumination rendering result into the fifth render texture 5025 in the geometry buffer 502.

Operation 409: Write the illumination rendering result stored in the on-chip memory into a main memory.

Further, the GPU writes the illumination rendering result stored in the on-chip memory into the main memory, to complete rendering of a tile. When a next tile needs to be rendered, the GPU clears rendering results stored in the on-chip memory, starts rendering the next tile, and finally completes rendering of the entire virtual scene based on a rendering result of each tile.

For example, as shown in FIG. 5, the GPU writes the fifth render texture 5025 in which the illumination rendering result of a current tile is located and stored in the on-chip memory into the main memory.

In the embodiments of this application, a GPU creates a render texture for storing a geometry rendering result in a geometry buffer of an on-chip memory, and creates a render texture for storing an illumination rendering result in the geometry buffer, to ensure that no switching of render textures occurs at a geometry rendering stage and an illumination rendering stage, and only writes the final illumination rendering result into a main memory, thereby reducing occupation of a memory. In addition, based on a first expansion characteristic, the GPU can read the geometry rendering result from the render texture, and only exchanges data with the on-chip memory at the entire rendering stage, thereby improving rendering efficiency and reducing bandwidth consumption.

In addition, by using the inout keyword to define the input and output variables, the fragment shader can directly read data from the on-chip memory by using the expansion characteristic during reading of the render texture, thereby ensuring that a result at the corresponding geometry rendering stage is further rendered at the illumination rendering state, and ensuring accuracy of the rendering process.

In another possible implementation, the illumination rendering may reuse a same render texture as the geometry rendering. After the illumination rendering ends, the geometry rendering result stored in the render texture is no longer required. Therefore, at the illumination rendering stage, after the GPU performs illumination rendering by using the second fragment shader, the GPU may directly overwrite and store the obtained illumination rendering result in any render texture. By reducing creation of a render texture storing the illumination rendering result, occupation of the on-chip memory may be further reduced.

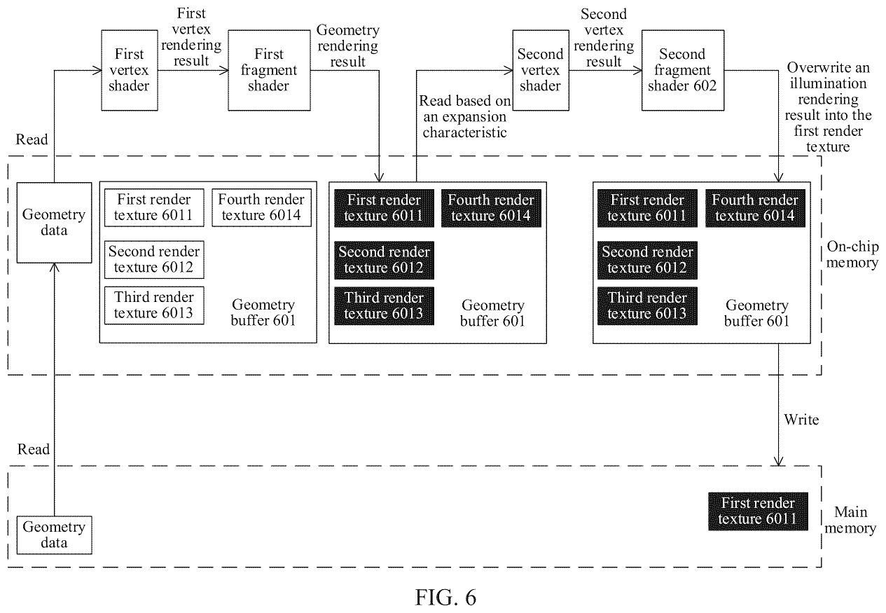

For example, as shown in FIG. 6, the GPU only creates four render textures in a geometry buffer 601, where a first render texture 6011 is configured for storing the color and ambient occlusion information of the virtual object, a second render texture 6012 is configured for storing the normal information of the virtual object, a third render texture 6013 is configured for storing the spontaneous light and highlights information of the virtual object, and a fourth render texture 6014 is configured for storing the depth information of the virtual object. After a second fragment shader 602 performs the illumination rendering and obtains the illumination rendering result, the GPU directly overwrites the illumination rendering result on the color and ambient occlusion information in the first render texture 6011. Further, the GPU writes the first render texture 6011 storing the illumination rendering result into the main memory.

In a possible implementation, the geometry rendering result does not need to be entirely stored in the render texture. The GPU may store a part of the geometry rendering result into the render texture, and directly store a remaining part of the geometry rendering result in the on-chip memory, thereby avoid a memory occupied by creation of an extra render texture. Correspondingly, for geometry rendering results in different storage manners, at the illumination rendering stage, the GPU obtains the geometry rendering results in different manners. An exemplary embodiment is provided below for description.

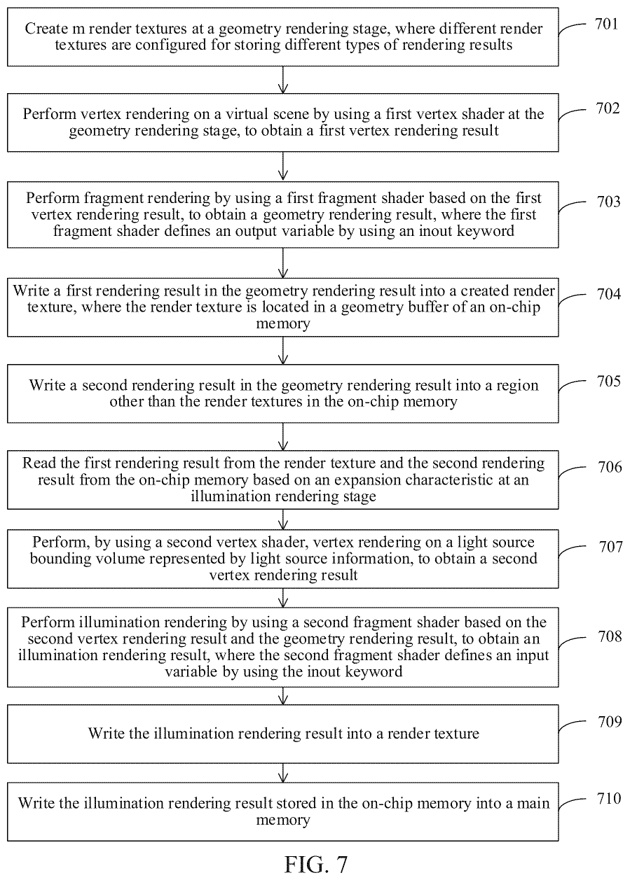

FIG. 7 is a flowchart of a method for rendering a virtual scene according to another exemplary embodiment of this application. The method may include the following operations:

Operation 701: Create m render textures at a geometry rendering stage, where the render textures are located in a geometry buffer of an on-chip memory, different render textures are configured for storing different types of rendering results, and m is an integer greater than or equal to 2.

To separately store different types of rendering results, the GPU creates m render textures, to correspondingly store the different types of rendering results into different render textures.

In this embodiment of this application, based on a second expansion characteristic, the GPU directly obtains rendering result information that can be obtained from the on-chip memory, without additionally creating a corresponding render texture. Therefore, m is less than n. In some embodiments, a difference between m and n is 1, and m is equal to n−1.

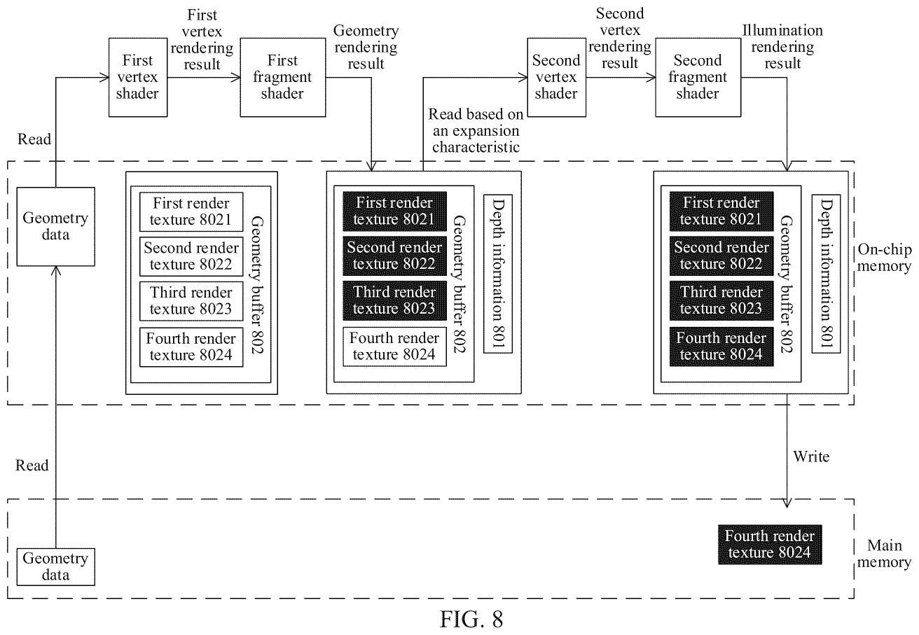

For example, as shown in FIG. 8, the GPU creates four render textures, where a first render texture 8021 is configured for storing the color and ambient occlusion information of the virtual object, a second render texture 8022 is configured for storing the normal information of the virtual object, a third render texture 8023 is configured for storing the spontaneous light and highlights information of the virtual object, and a fourth render texture 8024 is configured for storing a final rendering result at the illumination rendering stage.

Operation 702: Perform vertex rendering on the virtual scene by using a first vertex shader at the geometry rendering stage, to obtain a first vertex rendering result.

Operation 703: Perform fragment rendering by using a first fragment shader based on the first vertex rendering result, to obtain a geometry rendering result, where the first fragment shader defines an output variable by using an inout keyword.

For implementations of Operation 702 and Operation 703, reference may be made to Operation 402 and Operation 403. Details are not described in this embodiment.

Operation 704: Write a first rendering result in the geometry rendering result into a created render texture.

In a possible implementation, the GPU writes the first rendering result defined by the inout keyword in the geometry rendering result into a created render texture, where the render texture is located in the geometry buffer of the on-chip memory, and the on-chip memory is a tile memory.

In a possible implementation, the first rendering result includes rendering information other than the depth information, and the rendering information may be the color information, the normal information, the spontaneous light information, or the like.

In a possible implementation, the GPU writes the first rendering result in the geometry rendering result into first to (m−1)^{th} render textures, where the first to (m−1) th render textures correspond to different types of rendering results, and an m^{th} render texture is configured for storing the final rendering result at the illumination rendering stage.

For example, as shown in FIG. 8, there are four render textures in a geometry buffer 802 of the on-chip memory. The GPU writes the color and ambient occlusion information of the virtual object obtained at the geometry rendering stage into the first render texture 8021, writes the normal information of the virtual object into the second render texture 8022, and writes the spontaneous light and highlights information of the virtual object into the third render texture 8023.

Operation 705: Write a second rendering result in the geometry rendering result into a region other than the render textures in the on-chip memory.

In a possible implementation, the GPU directly writes the second rendering result in the geometry rendering result into the region other than the render textures in the on-chip memory, without creating a corresponding render texture for storing the second rendering result, thereby reducing occupation of the on-chip memory.

To ensure that the second rendering result can be normally read subsequently, a rendering type corresponding to the second rendering result needs to support direct reading from the on-chip memory through an expansion characteristic.

In a possible implementation, the second rendering result includes the depth information. Certainly, in addition to the depth information, the second rendering result may also include other types of information that support direct reading from the on-chip memory through an expansion characteristic. This is not limited in this embodiment of this application.

For example, as shown in FIG. 8, the GPU writes depth information 801 obtained in combination with rendering into the region other than the render textures in the on-chip memory.

Operation 706: Read the first rendering result from the render texture and the second rendering result from the on-chip memory based on an expansion characteristic at an illumination rendering stage.

Since the first rendering result and the second rendering result are stored at different positions of the on-chip memory, at the illumination rendering stage, the GPU reads the first rendering result and the second rendering result from the render texture and on-chip memory respectively based on different expansion characteristics.

In a possible implementation, based on a first expansion characteristic, the GPU reads the first rendering result from the render texture, where the first expansion characteristic is configured for expanding a manner in which the GPU reads data from the geometry buffer of the on-chip memory.

For the first rendering result stored in the render texture of the geometry buffer, the GPU reads the first rendering result from the render texture through the first expansion characteristic, where the first expansion characteristic is configured for expanding the manner in which the GPU reads data from the geometry buffer of the on-chip memory.

In an exemplary example, the first expansion characteristic is a mobile platform GPU OpenGLES GL_EXT_shader_framebuffer_fetch expansion characteristic. When the geometry rendering result is defined by using the inout keyword, and the render texture created at the geometry rendering stage is used (that is, switching of render textures does not occur), the GPU can directly read the first rendering result from the geometry buffer of the on-chip memory based on the first expansion characteristic.

In a possible implementation, the GPU reads the second rendering result from the on-chip memory based on a second expansion characteristic, where the second expansion characteristic is configured for expanding a manner in which the GPU reads the depth information from the on-chip memory.

For the second rendering result directly stored in the region other than the render textures in the on-chip memory, the GPU directly reads the second rendering result from the on-chip memory through the second expansion characteristic, where the second expansion characteristic is configured for expanding the manner in which the GPU reads the depth information from the on-chip memory.

In an exemplary example, the second expansion characteristic is a mobile platform GPU OpenGLES GL_ARM_shader_framebuffer_fetch_depth_stencil expansion characteristic. By using the second expansion characteristic, the GPU can directly read the depth information from a built-in variable gl_LastFragDepthARM in the on-chip memory.

Operation 707: Perform, by using a second vertex shader, vertex rendering on a light source bounding volume represented by light source information, to obtain a second vertex rendering result.

Operation 708: Perform illumination rendering by using a second fragment shader based on the second vertex rendering result and the geometry rendering result, to obtain an illumination rendering result, where the second fragment shader defines an input variable by using the inout keyword.

For implementations of Operation 707 and Operation 708, reference may be made to Operation 406 and Operation 407. Details are not described in this embodiment. Operation 709: Write the illumination rendering result into a render texture.

Further, the GPU writes the illumination rendering result into the m^{th} render texture, where the m^{th} render texture is located in the geometry buffer of the on-chip memory.

For example, as shown in FIG. 8, the GPU writes the illumination rendering result into the fourth render texture 8024, where the fourth render texture 8024 is located in the geometry buffer 802 of the on-chip memory.

Operation 710: Write the illumination rendering result stored in the on-chip memory into a main memory.

For an implementation of this Operation, reference may be made to Operation 409, and details are not described in this embodiment.

In this embodiment of this application, the GPU directly reads the depth information from the on-chip memory through the second expansion characteristic. This avoids creation of a corresponding render texture for the depth information, thereby ensuring that the depth information is correctly read, and reducing occupation of the on-chip memory.

In a possible implementation, to reduce occupation of the on-chip memory, at the illumination rendering stage, after performing illumination rendering by using the second fragment shader, the GPU directly overwrites and stores the obtained illumination rendering result in any render texture in the geometry buffer in a manner of multiplexing the render texture.

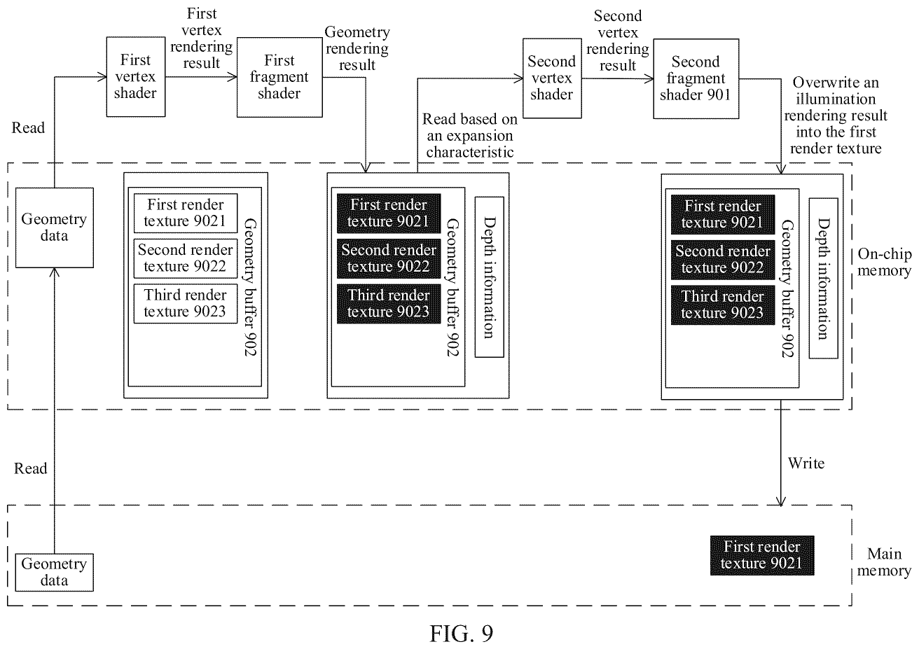

For example, as shown in FIG. 9, the GPU only creates three render textures in a geometry buffer 902, where a first render texture 9021 is configured for storing the color and ambient occlusion information of the virtual object, a second render texture 9022 is configured for storing the normal information of the virtual object, and a third render texture 9023 is configured for storing the spontaneous light and highlights information of the virtual object. After performing illumination rendering by using a second fragment shader 901 and obtaining the illumination rendering result, the GPU directly overwrites the illumination rendering result on the color and ambient occlusion information in the first render texture 9021. Further, the GPU writes the first render texture 9021 storing the illumination rendering result into the main memory.

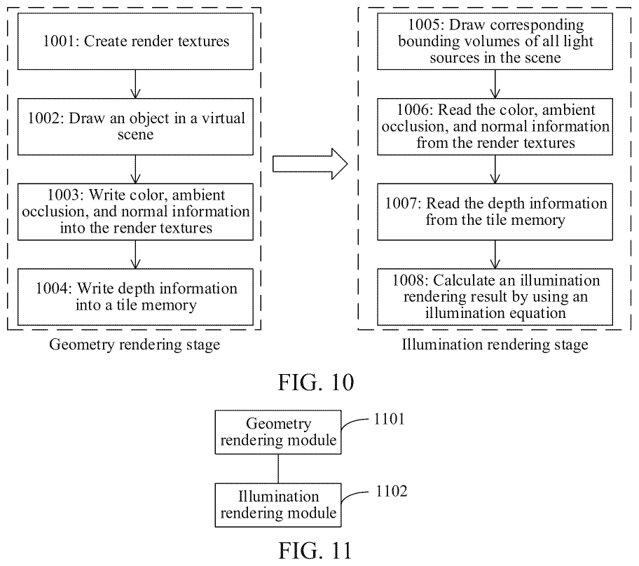

FIG. 10 is a flowchart of implementing multi-light source rendering based on an expansion characteristic according to an exemplary embodiment of this application.

Operation 1001: Create render textures.

The GPU creates four render textures, where a first render texture is configured for storing the color and ambient occlusion information of the virtual object, a second render texture is configured for storing the normal information of the virtual object, a third render texture is configured for storing the spontaneous light and highlights of the virtual object, and a fourth render texture is configured for storing the final rendering result at the illumination rendering stage.

Operation 1002: Draw an object in a virtual scene.

The GPU draws the virtual object in the virtual scene, and performs geometry rendering according to geometry data obtained through drawing, to obtain the geometry rendering result, including the color, ambient occlusion, normal, spontaneous light, and highlights information.

Operation 1003: Write color, ambient occlusion, normal, spontaneous light, and highlights information into the render textures.

The GPU writes the color, ambient occlusion, normal, spontaneous light, and highlights information into corresponding render textures, where the render textures are located in the geometry buffer of the tile memory.

Operation 1004: Write depth information into a tile memory.

Based on the second expansion characteristic, the GPU directly writes the depth information into the tile memory, where the second expansion characteristic is a mobile platform GPU OpenGLES GL_ARM_shader_framebuffer_fetch_depth_stencil expansion characteristic.

Operation 1005: Draw corresponding bounding volumes of all light sources in the scene.

According to different types of light sources in the scene, the GPU draws the corresponding bounding volumes of all the light sources in the scene, and performs vertex rendering on the light source bounding volume by using the second vertex shader, to obtain the second vertex rendering result.

Operation 1006: Read the color, ambient occlusion, normal, spontaneous light, and highlights information from the render textures.

The GPU reads the color, ambient occlusion, normal, spontaneous light, and highlights information from the render textures based on the first expansion characteristic, where the first expansion characteristic is a mobile platform GPU OpenGLES GL_EXT_shader_framebuffer_fetch expansion characteristic.

Operation 1007: Read the depth information from the tile memory.

Based on the second expansion characteristic, the GPU reads the depth information from a built-in variable gl_LastFragDepthARM in the tile memory.

Operation 1008: Calculate an illumination rendering result by using an illumination equation.

Based on the geometry rendering result and the second vertex rendering result, the GPU calculates the illumination rendering result by using the illumination equation.

FIG. 11 is a structural block diagram of an apparatus for rendering a virtual scene according to an exemplary embodiment of this application. The apparatus includes the following structures:
a geometry rendering module 1101, configured to perform geometry rendering on the virtual scene at a geometry rendering stage, to obtain a geometry rendering result; and
write the geometry rendering result into an on-chip memory, where the on-chip memory is a memory arranged in a GPU, and the geometry rendering result is not written into a main memory; and
an illumination rendering module 1102, configured to read the geometry rendering result from the on-chip memory based on an expansion characteristic at an illumination rendering stage, where the expansion characteristic is configured for expanding a manner in which the GPU reads data from the on-chip memory; perform illumination rendering based on light source information and the geometry rendering result, to obtain an illumination rendering result; and write the illumination rendering result into the on-chip memory.

In some embodiments, the geometry rendering module 1101 is configured to:
write the geometry rendering result into a created render texture, where the render texture is located in a geometry buffer of the on-chip memory;
the illumination rendering module 1102 is configured to:
read the geometry rendering result from the render texture based on a first expansion characteristic, where the first expansion characteristic is configured for expanding a manner in which the GPU reads data from the geometry buffer of the on-chip memory; and the illumination rendering module 1102 is further configured to:
write the illumination rendering result into the render texture.

In some embodiments,
the geometry rendering module 1101 is configured to create n render textures at the geometry rendering stage, where different render textures are configured for storing different types of rendering results, and n is an integer greater than or equal to 2;
the geometry rendering module 1101 is further configured to:
write the geometry rendering result into first to (n−1)^{th} render textures; and
the illumination rendering module 1102 is further configured to:
write the illumination rendering result into an n^{th} render texture.

In some embodiments, the geometry rendering module 1101 is configured to:
write a first rendering result in the geometry rendering result into a created
render texture, where the render texture is located in a geometry buffer of the on-chip memory; and
write a second rendering result in the geometry rendering result into a region other than the render texture in the on-chip memory;
the illumination rendering module 1102 is configured to:
read, based on the expansion characteristic, the first rendering result from the render texture and the second rendering result from the on-chip memory; and
the illumination rendering module 1102 is further configured to:
write the illumination rendering result into the render texture.

In some embodiments, the second rendering result includes depth information, and the first rendering result includes rendering information other than the depth information.

In some embodiments, the illumination rendering module 1102 is configured to:
read the first rendering result from the render texture based on a first expansion characteristic, where the first expansion characteristic is configured for expanding the manner in which the GPU reads data from the geometry buffer of the on-chip memory; and
read the second rendering result from the on-chip memory based on a second expansion characteristic, where the second expansion characteristic is configured for expanding a manner in which the GPU reads the depth information from the on-chip memory.

In some embodiments,
the geometry rendering module 1101 is further configured to create m render textures at the geometry rendering stage, where different render textures are configured for storing different types of rendering results, and m is an integer greater than or equal to 2;
the geometry rendering module 1101 is further configured to:
write the first rendering result in the geometry rendering result into first to (m−1)^{th} render textures; and
the illumination rendering module 1102 is further configured to:
write the illumination rendering result into an m^{th} render texture.

In some embodiments, the geometry rendering module 1101 is configured to:
perform vertex rendering on the virtual scene by using a first vertex shader, to obtain a first vertex rendering result; and
perform fragment rendering by using a first fragment shader based on the first vertex rendering result, to obtain the geometry rendering result, where the first fragment shader defines an output variable by using an inout keyword; and
the illumination rendering module 1102 is configured to:
perform, by using a second vertex shader, vertex rendering on a light source bounding volume represented by the light source information, to obtain a second vertex rendering result; and
perform illumination rendering by using a second fragment shader based on the second vertex rendering result and the geometry rendering result, to obtain the illumination rendering result, where the second fragment shader defines an input variable by using the inout keyword.

In some embodiments, the apparatus further includes:
a result writing module, configured to write the illumination rendering result stored in the on-chip memory into the main memory.

In some embodiments, the GPU is a mobile platform GPU, and the on-chip memory is a tile memory.

In summary, in the embodiments of this application, a GPU writes a geometry rendering result obtained at a geometry rendering stage into an on-chip memory of the GPU instead of a main memory, reads the geometry rendering result from the on-chip memory based on an expansion characteristic at an illumination rendering stage, to perform illumination rendering in combination with light source information, and writes an illumination rendering result into the on-chip memory. By using the solutions provided in the embodiments of this application, the GPU can directly read the geometry rendering result from the on-chip memory at the illumination rendering stage by using the expansion characteristic, which eliminates a link of writing the geometry rendering result into the main memory and reading the geometry rendering result from the main memory, reducing bandwidth consumption during rendering of a virtual environment.

The apparatus provided in the foregoing embodiments is only illustrated by taking the division of the foregoing functional modules as an example. In an actual application, the foregoing functions may be allocated to and completed by different functional modules according to requirements. In other words, an internal structure of the apparatus is divided into different functional modules, to complete all or some of the functions described above. In addition, the apparatus provided in the foregoing embodiments and the method embodiments belong to the same concept. For an implementation process of the apparatus, reference may be made to the method embodiments. Details are not described herein again.

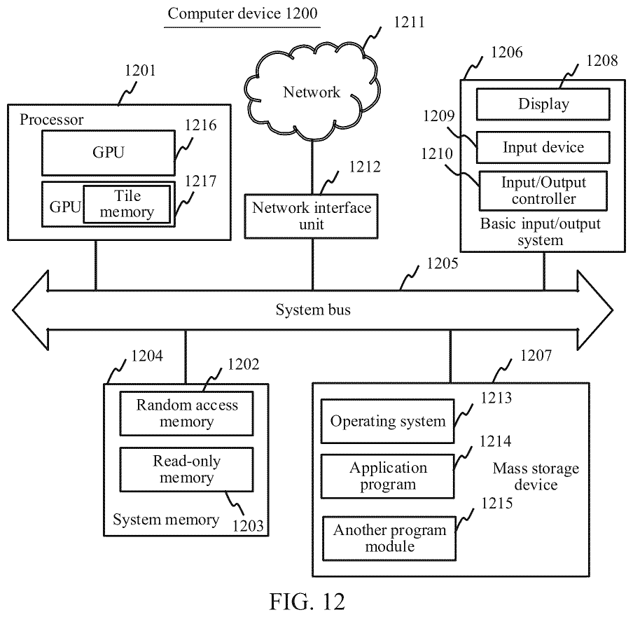

FIG. 12 is a schematic structural diagram of a computer device according to an exemplary embodiment of this application. Specifically, a computer device 1200 includes a processor 1201, a system memory 1204 that includes a random access memory 1202 and a read-only memory 1203, and a system bus 1205 connecting the system memory 1204 and the processor 1201. The computer device 1200 further includes a basic input/output system (I/O system) 1206 assisting in transmitting information between components in a computer, and a mass storage device 1207 configured to store an operating system 1213, an application program 1214, and another program module 1215.

The processor 1201 includes a central processing unit (CPU) 1216 and a graphics processing unit (GPU) 1217, where a tile memory is arranged in the graphics processing unit 1217, and the graphics processing unit is configured to implement the method for rendering a virtual scene in the embodiments of this application.

The basic input/output system 1206 includes a display 1208 configured to display information and an input device 1209 such as a mouse or a keyboard for a user to input information. The display 1208 and the input device 1209 are both connected to the processor 1201 by using an input and output controller 1210 connected to the system bus 1205. The basic input/output system 1206 may further include the input and output controller 1210 for receiving and processing inputs from a plurality of other devices such as a keyboard, a mouse, or an electronic stylus. Similarly, the input/output controller 1210 further provides an output to a display screen, a printer, or another type of output device.

The mass storage device 1207 is connected to the processor 1201 by using a mass storage controller (not shown) connected to the system bus 1205. The mass storage device 1207 and a computer-readable medium associated with the mass storage device 1207 provide non-volatile storage to the computer device 1200. That is, the mass storage device 1207 may include a computer-readable medium (not shown) such as a hard disk or a drive.

Without loss of generality, the computer-readable medium may include a computer storage medium and a communication medium. The computer storage medium includes volatile and non-volatile, removable and non-removable media that store information such as computer-readable instructions, data structures, program modules, or other data and that are implemented by using any method or technology. The computer storage medium includes a random access memory (RAM), a read-only memory (ROM), a flash memory or another solid-state storage technology, a compact disc read-only memory (CD-ROM), a digital versatile disc (DVD) or another optical memory, a magnetic cassette, a magnetic tape, a magnetic disk storage or another magnetic storage device. Certainly, it may be known by a person skilled in the art that the computer storage medium is not limited to the foregoing several types. The system memory 1204 and the mass storage device 1207 may be collectively referred to as a memory.

The memory stores one or more programs, where the one or more programs are configured to be executed by one or more processors 1201, and the one or more programs include instructions for implementing the foregoing methods. The processor 1201 executes the one or more programs to implement the methods provided in the foregoing method embodiments.

According to the embodiments of this application, the computer device 1200 may further be connected, through a network such as the Internet, to a remote computer on the network and run. That is, the computer device 1200 may be connected to a network 1212 by using a network interface unit 1211 connected to the system bus 1205, or may be connected to another type of network or a remote computer system (not shown) by using a network interface unit 1211.

An embodiment of this application further provides a non-transitory computer-readable storage medium, having at least one instruction stored therein, where the at least one instruction is loaded and executed by a processor to implement the method for rendering a virtual scene according to the foregoing embodiments.

An embodiment of this application provides a computer program product or a computer program. The computer program product or the computer program includes computer instructions, where the computer instructions are stored in a computer-readable storage medium. A processor of a computer device reads the computer instructions from the computer-readable storage medium, and the processor executes the computer instructions, to cause the computer device to perform the method for rendering a virtual scene according to the foregoing embodiments.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A method for rendering a virtual scene performed by a computer device, the method comprising:
performing geometry rendering on the virtual scene at a geometry rendering stage, to obtain a geometry rendering result;
writing the geometry rendering result into an on-chip memory in a GPU;
reading the geometry rendering result from the on-chip memory based on an expansion characteristic in which the GPU reads data from the on-chip memory at an illumination rendering stage;
performing illumination rendering based on light source information and the geometry rendering result, to obtain an illumination rendering result; and
writing the illumination rendering result into the on-chip memory.

2. The method according to claim 1, wherein the writing the geometry rendering result into an on-chip memory in a GPU comprises:
writing the geometry rendering result into a created render texture, wherein the render texture is located in a geometry buffer of the on-chip memory;
the reading the geometry rendering result from the on-chip memory based on an expansion characteristic comprises:
reading the geometry rendering result from the render texture based on a first expansion characteristic in which the GPU reads data from the geometry buffer of the on-chip memory; and
the writing the illumination rendering result into the on-chip memory comprises:
writing the illumination rendering result into the render texture.

3. The method according to claim 2, wherein the method further comprises:
creating n render textures at the geometry rendering stage, wherein different render textures are configured for storing different types of rendering results, and n is an integer greater than or equal to 2;
the writing the geometry rendering result into a created render texture comprises:
writing the geometry rendering result into first to (n−1)^{th} render textures; and
the writing the illumination rendering result into the render texture comprises:
writing the illumination rendering result into an n^{th} render texture.

4. The method according to claim 1, wherein the writing the geometry rendering result into an on-chip memory in a GPU comprises:
writing a first rendering result in the geometry rendering result into a created render texture, wherein the render texture is located in a geometry buffer of the on-chip memory; and
writing a second rendering result in the geometry rendering result into a region other than the render texture in the on-chip memory;
the reading the geometry rendering result from the on-chip memory based on an expansion characteristic comprises:
reading, based on the expansion characteristic, the first rendering result from the render texture and the second rendering result from the on-chip memory; and
the writing the illumination rendering result into the on-chip memory comprises:
writing the illumination rendering result into the render texture.

5. The method according to claim 4, wherein the second rendering result comprises depth information, and the first rendering result comprises rendering information other than the depth information.

6. The method according to claim 1, wherein the performing geometry rendering on the virtual scene, to obtain a geometry rendering result comprises:
performing vertex rendering on the virtual scene by using a first vertex shader, to obtain a first vertex rendering result; and
performing fragment rendering by using a first fragment shader based on the first vertex rendering result, to obtain the geometry rendering result, wherein the first fragment shader defines an output variable by using an inout keyword; and
the performing illumination rendering based on light source information and the geometry rendering result, to obtain an illumination rendering result comprises:
performing, by using a second vertex shader, vertex rendering on a light source bounding volume represented by the light source information, to obtain a second vertex rendering result; and
performing illumination rendering by using a second fragment shader based on the second vertex rendering result and the geometry rendering result, to obtain the illumination rendering result, wherein the second fragment shader defines an input variable by using the inout keyword.

7. The method according to claim 1, wherein the method further comprises:
writing the illumination rendering result stored in the on-chip memory into the main memory.

8. The method according to claim 1, wherein the GPU is a mobile platform GPU, and the on-chip memory is a tile memory.

9. A computer device, comprising a processor and a memory; the memory having at least one instruction stored therein that, when executed by the processor, causes the computer device to implement a method for rendering a virtual scene including:
performing geometry rendering on the virtual scene at a geometry rendering stage, to obtain a geometry rendering result;
writing the geometry rendering result into an on-chip memory in a GPU;
reading the geometry rendering result from the on-chip memory based on an expansion characteristic in which the GPU reads data from the on-chip memory at an illumination rendering stage;
performing illumination rendering based on light source information and the geometry rendering result, to obtain an illumination rendering result; and
writing the illumination rendering result into the on-chip memory.

10. The computer device according to claim 9, wherein the writing the geometry rendering result into an on-chip memory in a GPU comprises:
writing the geometry rendering result into a created render texture, wherein the render texture is located in a geometry buffer of the on-chip memory;
the reading the geometry rendering result from the on-chip memory based on an expansion characteristic comprises:
reading the geometry rendering result from the render texture based on a first expansion characteristic in which the GPU reads data from the geometry buffer of the on-chip memory; and
the writing the illumination rendering result into the on-chip memory comprises:
writing the illumination rendering result into the render texture.

11. The computer device according to claim 10, wherein the method further comprises:
creating n render textures at the geometry rendering stage, wherein different render textures are configured for storing different types of rendering results, and n is an integer greater than or equal to 2;
the writing the geometry rendering result into a created render texture comprises:
writing the geometry rendering result into first to (n−1)^{th} render textures; and
the writing the illumination rendering result into the render texture comprises:
writing the illumination rendering result into an n^{th} render texture.

12. The computer device according to claim 9, wherein the writing the geometry rendering result into an on-chip memory in a GPU comprises:
writing a first rendering result in the geometry rendering result into a created render texture, wherein the render texture is located in a geometry buffer of the on-chip memory; and
writing a second rendering result in the geometry rendering result into a region other than the render texture in the on-chip memory;
the reading the geometry rendering result from the on-chip memory based on an expansion characteristic comprises:
reading, based on the expansion characteristic, the first rendering result from the render texture and the second rendering result from the on-chip memory; and
the writing the illumination rendering result into the on-chip memory comprises:
writing the illumination rendering result into the render texture.

13. The computer device according to claim 12, wherein the second rendering result comprises depth information, and the first rendering result comprises rendering information other than the depth information.

14. The computer device according to claim 9, wherein the performing geometry rendering on the virtual scene, to obtain a geometry rendering result comprises:
performing vertex rendering on the virtual scene by using a first vertex shader, to obtain a first vertex rendering result; and
performing fragment rendering by using a first fragment shader based on the first vertex rendering result, to obtain the geometry rendering result, wherein the first fragment shader defines an output variable by using an inout keyword; and
the performing illumination rendering based on light source information and the geometry rendering result, to obtain an illumination rendering result comprises:
performing, by using a second vertex shader, vertex rendering on a light source bounding volume represented by the light source information, to obtain a second vertex rendering result; and
performing illumination rendering by using a second fragment shader based on the second vertex rendering result and the geometry rendering result, to obtain the illumination rendering result, wherein the second fragment shader defines an input variable by using the inout keyword.

15. The computer device according to claim 9, wherein the method further comprises:
writing the illumination rendering result stored in the on-chip memory into the main memory.

16. The computer device according to claim 9, wherein the GPU is a mobile platform GPU, and the on-chip memory is a tile memory.

17. A non-transitory computer-readable storage medium, having at least one piece of program code stored therein that, when executed by a processor of a computer device, causes the computer device to implement a method for rendering a virtual scene including:
performing geometry rendering on the virtual scene at a geometry rendering stage, to obtain a geometry rendering result;
writing the geometry rendering result into an on-chip memory in a GPU;
reading the geometry rendering result from the on-chip memory based on an expansion characteristic in which the GPU reads data from the on-chip memory at an illumination rendering stage;
performing illumination rendering based on light source information and the geometry rendering result, to obtain an illumination rendering result; and
writing the illumination rendering result into the on-chip memory.

18. The non-transitory computer-readable storage medium according to claim 17, wherein the writing the geometry rendering result into an on-chip memory in a GPU comprises:
writing the geometry rendering result into a created render texture, wherein the render texture is located in a geometry buffer of the on-chip memory;
the reading the geometry rendering result from the on-chip memory based on an expansion characteristic comprises:
reading the geometry rendering result from the render texture based on a first expansion characteristic in which the GPU reads data from the geometry buffer of the on-chip memory; and
the writing the illumination rendering result into the on-chip memory comprises:
writing the illumination rendering result into the render texture.

19. The non-transitory computer-readable storage medium according to claim 17, wherein the writing the geometry rendering result into an on-chip memory in a GPU comprises:
writing a first rendering result in the geometry rendering result into a created render texture, wherein the render texture is located in a geometry buffer of the on-chip memory; and
writing a second rendering result in the geometry rendering result into a region other than the render texture in the on-chip memory;
the reading the geometry rendering result from the on-chip memory based on an expansion characteristic comprises:
reading, based on the expansion characteristic, the first rendering result from the render texture and the second rendering result from the on-chip memory; and
the writing the illumination rendering result into the on-chip memory comprises:
writing the illumination rendering result into the render texture.

20. The non-transitory computer-readable storage medium according to claim 19, wherein the second rendering result comprises depth information, and the first rendering result comprises rendering information other than the depth information.
